(19) United States
(12) Patent Application Publication
(10) Pub. No.: US 2011/0082809 A1
(43) Pub. Date: Apr. 7, 2011

(54) Integrated Institution Application Management System

(76) Inventor: Praveen K. Andapally, Edison, NJ (US)

(21) Appl. No.: 12/896,854

(22) Filed: Oct. 2, 2010

Related U.S. Application Data
(60) Provisional application No. 61/248,500, filed on Oct. 5, 2009.

(51) Int. Cl. G06Q 50/00

(52) U.S. Cl. 705/327

(57) ABSTRACT

A computer implemented method and system is provided for allowing an applicant to apply for admission to multiple institutions in an online environment. An application management platform comprising an online interface is provided to an applicant. The application management platform provides a list of institutions to the applicant. The applicant selects one or more institutions listed on the online interface. The application management platform identifies applicant information sought by the selected institutions by parsing application forms associated with the selected institutions. The application management platform generates a universal application form comprising a consolidated set of input fields corresponding to the identified applicant information. The application management platform captures the applicant information filled into the consolidated set of input fields of the dynamically generated universal application form via the online interface. The application management platform selectively transmits the captured applicant information from the filled universal application form to the selected institutions.

### CROSS REFERENCE TO RELATED APPLICATIONS

This application claims the benefit of provisional patent application No. 61/248,500 titled “Integrated Institution Application Management System”, filed on Oct. 5, 2009 in the United States Patent and Trademark Office.

The specification of the above referenced patent application is incorporated herein by reference in its entirety.

### BACKGROUND

Each year, more than two hundred thousand applicants apply for admission to US and foreign educational institutions from different parts of the world for academic programs, for example, Bachelor's degrees, Master's degrees, Doctor of Philosophy (Ph.D.) degrees, etc. To obtain admission in such programs, the applicants are required to apply to each of the institutions by filling out and submitting numerous application forms at the institutions at which the applicants apply for admission. Consequently, the applicants have to spend significant time to complete the same or similar application forms for each of the institutions to which they apply. This is a burden on the applicants and results in the applicants performing redundant work.

Hence, there is a long felt but unresolved need for a computer implemented method and system that allows applicants to apply for admission to multiple institutions in an online environment in an integrated manner that eliminates redundant paperwork, thereby making the applicants' job simpler and bridging the gap between the applicants' and the institutions' requirements by providing an international gateway for any applicant who is aspiring to study or work in the US or abroad.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for allowing an applicant to apply for admission to multiple institutions in an online environment by completing minimal forms. The computer implemented method and system disclosed herein also eliminates redundant paperwork making the applicant's job simpler and bridges the gap between the applicant's and the institutions' requirements by providing a gateway for an applicant who is aspiring to study or work at an institution in the US or abroad.

In the computer implemented method and system disclosed herein, an application management platform is provided to the applicant. The application management platform provides an online interface to the applicant for applying to the institutions in an online environment. In an embodiment, the applicant and the institutions register with the application management platform. The application management platform provides a list of institutions to the applicant via the online interface. The applicant selects one or more institutions from the list. The application management platform identifies applicant information sought by the selected institutions by parsing application forms associated with the selected institutions. The application management platform dynamically generates a universal application form comprising a consolidated set of input fields corresponding to the identified applicant information. In an embodiment, the application management platform identifies unique applicant information sought by one or more institutions subsequently selected by the applicant on the online interface. The application management platform appends additional input fields corresponding to the identified unique applicant information to the consolidated set of input fields in the dynamically generated universal application form. In another embodiment, the application management platform generates an additional application form specific to each of the subsequently selected institutions. The additional application form comprises one or more additional input fields corresponding to the identified unique applicant information sought by the subsequently selected institutions.

In an embodiment, the institutions prescribe a format for filling the applicant information. One or more of the consolidated set of input fields in the dynamically generated universal application form prompts the applicant to fill the applicant information in the prescribed format. One or more of the consolidated set of input fields in the dynamically generated universal application form also allows the applicant to attach or upload one or more documents associated with the admission. Consolidation of the set of input fields in the dynamically generated universal application form for capturing the applicant information sought by the selected institutions in the online environment provides an integrated means for applying to the selected institutions.

The application management platform captures the applicant information when the applicant fills the applicant information into the consolidated set of input fields of the dynamically generated universal application form via the online interface. A data store residing on the application management platform periodically stores the captured applicant information. The application management platform automatically generates credentials for the applicant and the institutions for accessing the captured applicant information. The application management platform selectively transmits the captured applicant information from the filled universal application form to the selected institutions. In an embodiment, the application management platform automatically fills in the application forms associated with the selected institutions using the captured applicant information from the filled universal application form. The application management platform then selectively transmits the filled application forms to the selected institutions.

In an embodiment, the application management platform generates reports using the captured applicant information based on requirements of the selected institutions. In an embodiment, the application management platform captures electronic payment details from the applicant via the online interface and transmits fees associated with the admission to the selected institutions over multiple secure connections. The application management platform tracks the status of the admission of the applicant to each of the selected institutions. In an embodiment, the application management platform provides a messaging interface in association with the online interface for enabling interactive communication between the applicant and the selected institutions.

The computer implemented method and system disclosed herein enables the applicant to fill out a single universal application form, instead of filling out multiple application forms for the selected institutions. The universal application form can be used by multiple institutions that the applicant has selected. This reduces the amount of work for the applicant and streamlines the admission process to the selected institutions. The application management platform is an intuitive interface and saves time by eliminating duplicate data entry from the applicant.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for allowing an applicant to apply for admission to multiple institutions in an online environment.

FIG. 2 illustrates a computer implemented system for allowing an applicant to apply for admission to multiple institutions in an online environment.

FIG. 3 exemplarily illustrates the architecture of a computer system employed for allowing an applicant to apply for admission to multiple institutions in an online environment.

FIG. 4 exemplarily illustrates the interaction between an applicant and the application management platform, when the applicant applies for admission to multiple institutions in an online environment.

FIGS. 5A-5B exemplarily illustrate a flow chart for allowing an applicant or an agent on behalf of the applicant to apply for admission to multiple institutions in an online environment.

FIGS. 6A-6B exemplarily illustrate a flow chart for allowing an applicant to apply for admission to multiple institutions in an online environment.

FIGS. 7A-7B exemplarily illustrate a flow chart for allowing an agent on behalf of the applicant to apply for admission to multiple institutions in an online environment.

FIG. 8 exemplarily illustrates a screenshot of an online interface provided by the application management platform for enabling an applicant to log in to the application management platform.

FIG. 9 exemplarily illustrates a screenshot of the online interface for enabling the applicant to select one or more institutions from a list of institutions for admission.

FIG. 10 exemplarily illustrates a screenshot of the online interface displaying a dynamically generated universal application form.

FIG. 11 exemplarily illustrates a screenshot of the online interface for tracking status of admission of multiple applicants to selected institutions on the application management platform.

### DETAILED DESCRIPTION OF THE INVENTION

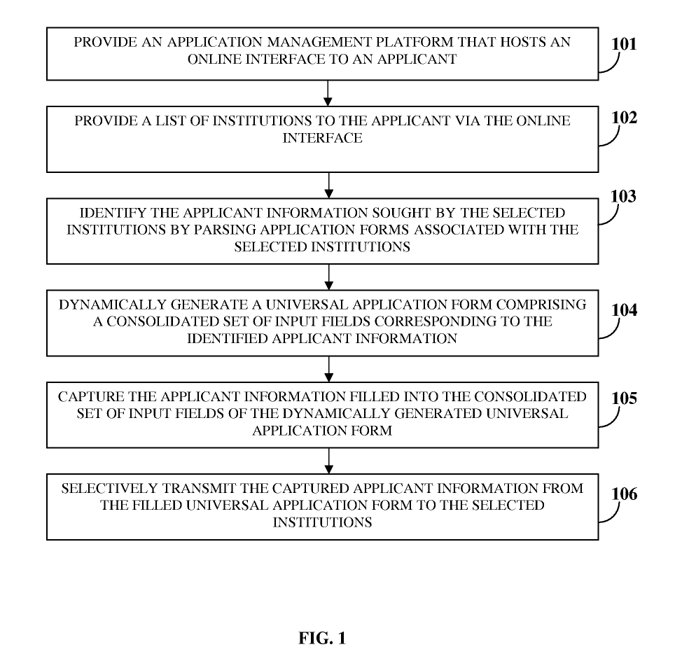

FIG. 1 illustrates a computer implemented method for allowing an applicant to apply for admission to multiple institutions in an online environment. An application management platform is provided 101 to the applicant. As used herein, the term “applicant” refers to a person or a group of persons applying to one or more institutions for a study course, a placement, a job, a service, etc., using the application management platform. An institution is, for example, an academic institution, a business organization, etc. The application management platform provides an online interface to the applicant for applying to the institutions in the online environment. The online interface is, for example, a website page. In an embodiment, the institutions register with the application management platform. Each of the institutions creates an account and obtains an institution identifier and password for accessing the account. During registration, every institution provides institution information, for example, the institution's name, a desired institution name, and contact information such as mailing address, phone number, electronic mail (email) address, etc., of the institution. The institutions may also upload their application forms on the application management platform via the online interface. In an embodiment, the applicant registers with the application management platform to create an account and obtains an applicant identifier and password for accessing the account. During registration, the applicant provides applicant information, for example, applicant's name, applicant's age, a desired username for the applicant, and contact information such as mailing address, phone number, email address, etc. The applicant and the institutions enter their basic information via the online interface hosted on the application management platform.

When the applicant accesses the application management platform, the application management platform provides 102 a list of institutions to the applicant via the online interface. The applicant selects one or more institutions from the list via the online interface. The applicant selects the institutions, for example, based on information received via a messaging interface provided by the application management platform. In an embodiment, the application management platform provides the messaging interface, for example, an instant messaging interface, in association with the online interface for enabling interactive communication between the applicant and the selected institutions. The applicant also obtains online counseling over the messaging interface or through other means for short listing institutions or job opportunities. For example, the applicant can attend job interviews, phone interviews, obtain responses to queries etc., via the messaging interface. The messaging interface appears embedded within the web pages of the online interface or appears as a pop up window.

The application management platform identifies 103 applicant information sought by the selected institutions by parsing application forms associated with the selected institutions. The application management platform dynamically generates 104 a universal application form comprising a consolidated set of input fields corresponding to the identified applicant information. As used herein, the term “input fields” refers to user-input sections, for example, text fields, check boxes, drop down list boxes, free form text areas, radio buttons, file upload controls, submit buttons, etc., in the dynamically generated universal application form. The consolidated set of inputs fields comprises input fields corresponding to the applicant information sought by the selected institutions without any repetition of common input fields. Consolidation of the set of input fields in the dynamically generated universal application form for capturing the applicant information sought by the selected institutions in the online environment provides an integrated means for applying to multiple institutions, without duplicate data entry from the applicant.

The institutions may require certain applicant information in prescribed formats. For example, the name of the applicant is required to be filled out in a certain format, for example, last name-first name-middle name. In an embodiment, the institutions prescribe a format for filling the applicant information. The application management platform generates inputs fields with prompts to fill the applicant information in the prescribed format. One or more input fields of the consolidated set of input fields in the dynamically generated universal application form therefore prompt the applicant to fill the applicant information in the prescribed format. In an embodiment, one or more input fields of the consolidated set of input fields in the dynamically generated universal application form allows the applicant to attach or upload one or more documents, for example, resumes, identity cards, academic reports, etc., associated with the admission. For example, an input field providing file upload controls allows the applicant to enter a filename or browse for a document on a local computer and attach the document to the dynamically generated universal application form.

The application management platform captures 105 the applicant information when the applicant fills the applicant information into the consolidated set of input fields of the dynamically generated universal application form via the online interface. In an embodiment, the online interface comprises controls to store the captured applicant information in a data store residing on the application management platform at regular intervals in case a connection to the application management platform over a network times out or gets inadvertently disconnected. In an embodiment, the online interface automatically stores the captured applicant information in the data store at regular intervals. In an embodiment, the applicant interacts with the messaging interface to obtain real time assistance of support staff while filling out the dynamically generated universal application form. In an embodiment, the application management platform reformats the captured applicant information to conform to the prescribed formats of the institutions. The application management platform automatically generates credentials for the applicant and the institutions for accessing the captured applicant information.

In an embodiment, the application management platform extends the universal application form to incorporate application forms from subsequently selected institutions. The applicant may subsequently select one or more other institutions for applying to those institutions. The application forms associated with multiple institutions typically have several fields that are common to the institutions. For example, applicant information such as name, date of birth, country of citizenship, etc., is typically required in every application form. The application management platform identifies unique applicant information sought by one or more institutions subsequently selected by the applicant on the online interface. As used herein, the term “unique applicant information” refers to applicant information that is specific to an institution and distinct from applicant information sought by other institutions. The application management platform parses the application forms associated with the institutions subsequently selected by the applicant for identification of the unique applicant information. In an embodiment, the application management platform appends additional input fields corresponding to the identified unique applicant information to the consolidated set of input fields in the dynamically generated universal application form. For example, one of the institutions subsequently selected by the applicant may require scholarship details of the applicant. In this example, the application management platform appends additional input fields corresponding to the scholarship details of the applicant to the consolidated set of input fields in the dynamically generated universal application form. The applicant can then fill out the dynamically generated universal application form with applicant information sought by the initially selected institutions and the subsequently selected institutions in the single dynamically generated universal application form. Therefore, the application management platform extends the universal application form to incorporate application forms from the subsequently selected institutions by updating the universal application form with the additional input fields specific to the application forms of the subsequently selected institutions, if those input fields were not present previously.

In another embodiment, the application management platform generates an additional application form specific to each of the subsequently selected institutions. The additional application form comprises additional input fields corresponding to the identified unique applicant information sought by each of the subsequently selected institutions. For example, one of the institutions subsequently selected by the applicant may require scholarship details of the applicant. In this example, the application management platform generates an additional application form specific to that institution, comprising additional input fields for accepting scholarship details of the applicant.

The application management platform selectively transmits 106 the captured applicant information from the filled universal application form to the selected institutions. For example, selective portions of the captured applicant information are sent to the institutions based on the information required by the institutions as identified in their respective application forms. The application management platform selectively transmits the captured information to the selected institutions, for example, via email, etc. In an embodiment, the application management platform selectively transmits information to the selected institutions' accounts on the application management platform. In an embodiment, the application management platform automatically fills in the respective application form of each of the selected institutions by retrieving the captured applicant information from the filled universal application form. The application management platform then transmits the filled application forms to the selected institutions, for example, via email, the messaging interface, and other electronic communication and messaging modes. In an embodiment, the application management platform generates reports using the captured applicant information and transmits the generated reports to the selected institutions based on requirements of the selected institutions.

In another embodiment, the application management platform provides a fee payment interface in association with the online interface that allows the applicant to transmit fees, for example, application fees, associated with admission to the selected institutions. The fee payment interface comprises fields for capturing electronic payment details from the applicant and transmits the captured electronic payment details to the selected institutions over secure connections. For example, the fee payment interface may be associated with online payment processing services, for example, PayPal™ of eBay® Inc. The online interface also provides a notification area, for example, a mailbox associated with the applicant's account on the application management platform where the applicant may receive, for example, prospective admission notifications from one or more institutions to which the applicant has applied. The application management platform tracks the status of the admission of the applicant to each of the selected institutions by tracking one or more application forms associated with each of the selected institutions. The application management platform updates the status of admission of the applicant based on the tracked status of the admission and notifies the applicant accordingly.

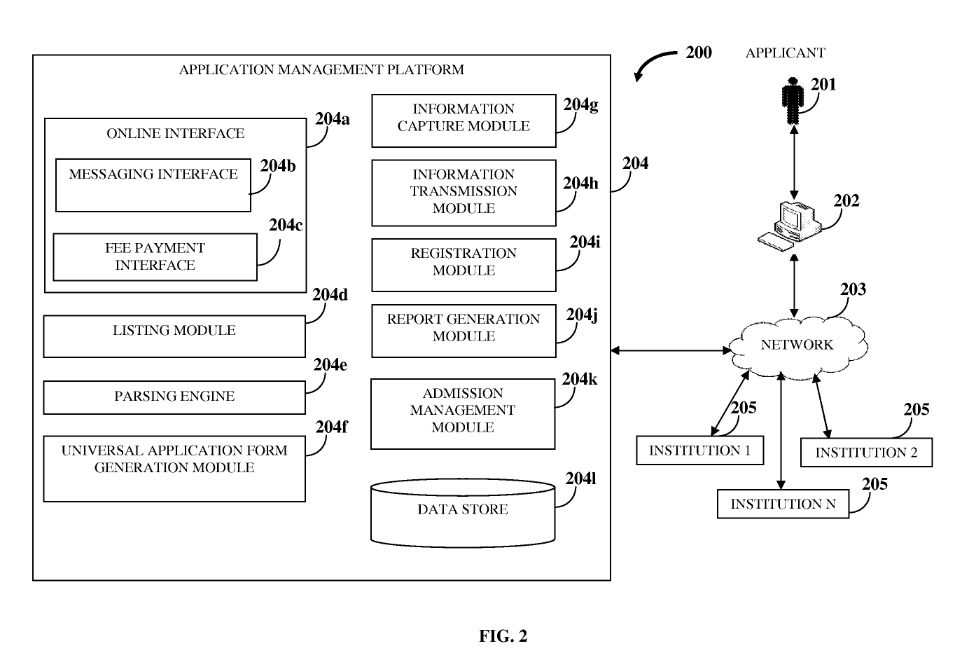

FIG. 2 illustrates a computer implemented system 200 for allowing an applicant 201 to apply for admission to multiple institutions 205 in an online environment. The computer implemented system 200 disclosed herein comprises an application management platform 204, for example, an online server, accessible by the applicant 201 and multiple institutions 205 in the online environment. The applicant 201 accesses the application management platform 204 by using a computing device 202, for example, a client computer or a mobile phone via a network 203. The network 203 is, for example, the internet, intranet, a local area network, a wide area network, a WiFi communication network, a Bluetooth™ communication network, an infrared communication network, etc. The application management platform 204 comprises an online interface 204a, a listing module 204d, a parsing engine 204e, a universal application form generation module 204f, an information capture module 204g, an information transmission module 204h, a registration module 204i, a report generation module 204j, an admission management module 204k, and a data store 204l.

The online interface 204a hosted on the application management platform 204 enables the applicant 201 to apply to multiple institutions 205 in the online environment. The registration module 204i registers the applicant 201 and the institutions 205 with the application management platform 204. The registration module 204i automatically generates credentials for the applicant 201 and the institutions 205 for accessing the captured applicant information. The listing module 204d provides a list of institutions 205 to the applicant 201 via the online interface 204a. The applicant 201 selects one or more institutions 205 from the list on the online interface 204a. The parsing engine 204e identifies applicant information sought by the selected institutions 205 by parsing application forms associated with the selected institutions 205. The universal application form generation module 204f dynamically generates a universal application form comprising a consolidated set of input fields corresponding to the identified applicant information. The parsing engine 204e also identifies unique applicant information sought by one or more institutions 205 subsequently selected by the applicant 201 on the online interface 204a. The universal application form generation module 204f appends additional input fields corresponding to the identified unique applicant information to the consolidated set of input fields in the dynamically generated universal application form. In an embodiment, the universal application form generation module 204f generates an additional application form specific to each of the subsequently selected institutions 205. The additional application form comprises additional input fields corresponding to the identified unique applicant information.

The information capture module 204g captures the applicant information filled into the consolidated set of input fields of the dynamically generated universal application form by the applicant 201 via the online interface 204a. The data store 204l periodically stores, for example, application forms, the dynamically generated universal application form, the captured applicant information, the filled universal application form, automatically filled application forms for selective transmission to the selected institutions 205, etc. The data store 204l also stores the captured applicant information at regular intervals in case a connection to the application management platform 204 over a network 203 times out or gets inadvertently disconnected. The information transmission module 204h selectively transmits the captured applicant information from the filled universal application form to the selected institutions 205.

The report generation module 204j generates reports using the captured applicant information based on requirements of the selected institutions 205. The admission management module 204k automatically fills in the application forms associated with the selected institutions 205 using the captured applicant information from the filled universal application form and tracks status of the admission of the applicant 201 to each of the selected institutions 205.

The online interface 204a comprises a messaging interface 204b and a fee payment interface 204c. The messaging interface 204b enables interactive communication between the applicant 201 and the selected institutions 205 via the application management platform 204. The fee payment interface 204c captures electronic payment details from the applicant 201 and transmits fees, for example, application fees, associated with the admission to the selected institutions 205 over one or more secure connections.

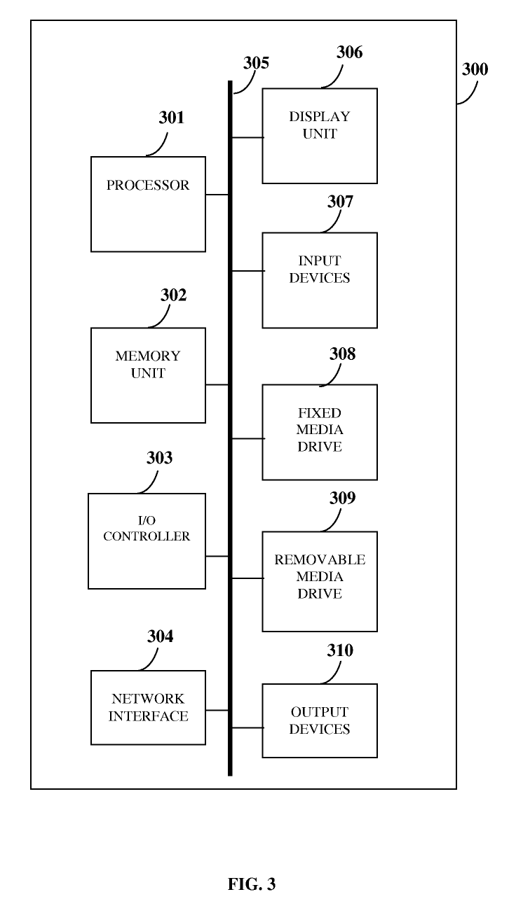

FIG. 3 exemplarily illustrates the architecture of a computer system 300 employed for allowing an applicant 201 to apply for admission to multiple institutions 205 in an online environment. In an embodiment, the application management platform 204 employs the architecture of the computer system 300 illustrated in FIG. 3.

The applicant 201 communicates with the application management platform 204 through the online interface 204a via a short range network or a long range network 203. The network 203 is, for example, a local area network (LAN), a wide area network, a mobile communication network, etc. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309, output devices 310, etc.

The processor 301 is an electronic circuit that can execute computer programs. The memory unit 302 is used for storing programs, applications, and data. For example, the universal application form generation module 204f is stored on the memory unit 302 of the computer system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 to the network 203. The computer system 300 communicates with other computer systems of, for example, the applicant 201, the institutions 205, etc., through the network interface 304. The network interface 304 comprises, for example, a Bluetooth™ interface, an infrared (IR) interface, a WiFi interface, a universal serial bus interface (USB), a local area network (LAN), a wide area network (WAN) interface, etc. The I/O controller 303 controls the input and output actions performed by the applicant 201. The data bus 305 permits communications between the modules, for example, 204d, 204e, 204f, 204g, 204h, 204i, 204j, 204k, etc., of the computer implemented system 200 disclosed herein.

The display unit 306 displays, via the online interface 204a, the results computed by the application management platform 204 to the applicant 201. The input devices 307 are used for inputting data into the computer system 300. The input devices 307 are, for example, a keyboard such as an alphanumeric keyboard, a joystick, a mouse, a touch pad, a light pen, etc. The computer system 300 further comprises a fixed media drive 308 and a removable media drive 309 for receiving removable media.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the network 203. Computer applications and programs are executed by double clicking a related icon displayed on the display unit 306 using one of the input devices 307. The applicant 201 and the institutions 205 interact with the computer system 300 using the application interfaces of the display unit 306.

The computer system 300 employed by the application management platform 204 employs an operating system for performing multiple tasks. The operating system is responsible for the management and coordination of activities and the sharing of the resources of the computer system 300. The operating system further manages security of the computer system 300, peripheral devices connected to the computer system 300, and network connections. The operating system employed on the computer system 300 recognizes, for example, inputs provided by the applicant 201 using one of the input devices 307, the output display, files, and directories stored locally on the fixed media drive 308, for example, a hard drive. The operating system on the computer system 300 executes different programs, for example, a web browser, an email application, etc., initiated by the applicant 201 using the processor 301. The processor 301 retrieves the instructions for executing the modules, for example, 204d, 204e, 204f, 204g, 204h, 204i, 204j, 204k, etc., of the application management platform 204 from the program memory in the form of signals. A program counter determines the location of the instructions in the program memory. The program counter stores a number that identifies the current position in the program of the modules, for example, 204d, 204e, 204f, 204g, 204h, 204i, 204j, 204k, etc., of the application management platform 204.

The instructions fetched by the processor 301 from the program memory after being processed are decoded. The instructions are placed in an instruction register in the processor 301. After processing and decoding, the processor 301 executes the instructions. For example, the listing module 204d defines instructions for listing the institutions 205 to the applicant 201 via the online interface 204a. The parsing engine 204e defines instructions for identifying applicant information sought by the selected institutions 205 by parsing application forms associated with the selected institutions 205. The universal application form generation module 204f defines instructions for dynamically generating a universal application form comprising a consolidated set of input fields corresponding to the identified applicant information. The parsing engine 204e also defines instructions for identifying unique applicant information sought by one or more institutions 205 subsequently selected by the applicant 201 on the online interface 204a. The universal application form generation module 204f defines instructions for appending additional input fields corresponding to the identified unique applicant information to the consolidated set of input fields in the dynamically generated universal application form. The universal application form generation module 204f defines instructions for generating an additional application form comprising additional input fields corresponding to the identified unique applicant information, specific to each of the subsequently selected institutions 205. The information capture module 204g defines instructions for capturing the applicant information filled into the consolidated set of input fields of the dynamically generated universal application form by the applicant 201 through the online interface 204a. The report generation module 204j defines instructions for generating reports using the captured applicant information based on requirements of the selected institutions 205. The admission management module 204k defines instructions for automatically filling in application forms associated with the selected institutions 205 using the captured applicant information from the filled universal application form and for tracking the status of the admission of the applicant 201 to each of the selected institutions 205. The information transmission module 204h defines instructions for selectively transmitting the captured applicant information from the filled universal application form to the selected institutions 205.

The processor 301 of the application management platform 204 retrieves the instructions defined by the listing module 204d, the parsing engine 204e, the universal application form generation module 204f, the report generation module 204j, the admission management module 204k, the information capture module 204g, and the information transmission module 204h and executes the instructions.

At the time of execution, the instructions stored in the instruction register are examined to determine the operations to be performed. The processor 301 then performs the specified operations. The operations include arithmetic and logic operations. The operating system performs multiple routines for performing a number of tasks required to assign the input devices 307, the output devices 310, and memory for execution of the modules, for example, 204d, 204e, 204f, 204g, 204h, 204i, 204j, 204k, etc., of the application management platform 204. The tasks performed by the operating system comprise assigning memory to the modules, for example, 204d, 204e, 204f, 204g, 204h, 204i, 204j, 204k, etc., of the application management platform 204 and data, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 204d, 204e, 204f, 204g, 204h, 204i, 204j, 204k, etc., of the application management platform 204 are displayed to the applicant 201, the institutions 205, an operator administering the application management platform 204, etc., on the online interface 204a.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 301, except for a transitory, propagating signal.

The computer program product disclosed herein comprises multiple computer program codes for allowing an applicant 201 to apply for admission to multiple institutions 205 in an online environment. For example, the computer program product disclosed herein comprises a first computer program code for providing an application management platform 204 that provides an online interface 204a to an applicant 201, a second computer program code for providing a list of institutions 205 to the applicant 201 via an online interface 204a, a third computer program code for identifying applicant information sought by the selected institutions 205 by parsing application forms associated with the selected institutions 205, a fourth computer program code for dynamically generating a universal application form comprising a consolidated set of input fields corresponding to the identified applicant information, a fifth computer program code for capturing the applicant information filled into the consolidated set of input fields of the dynamically generated universal application form by the applicant 201 via the online interface 204a, a sixth computer program code for selectively transmitting the captured applicant information from the filled universal application form to the selected institutions 205. The computer program product disclosed herein further comprises a seventh computer program code for identifying unique applicant information sought by one or more institutions 205 subsequently selected by the applicant 201 on the online interface 204a, and an eighth computer program code for appending additional input fields corresponding to the identified unique applicant information to the consolidated set of input fields in the dynamically generated universal application form. In an embodiment, a single piece of computer program code comprising computer executable instructions performs one or more steps of the computer implemented method disclosed herein for allowing an applicant 201 to apply for admission to multiple institutions 205 in an online environment.

The computer program codes comprising the computer executable instructions for allowing an applicant 201 to apply for admission to multiple institutions 205 in an online environment are embodied on the non-transitory computer readable storage medium. The processor 301 of the computer system 300 retrieves these computer executable instructions and executes them. When the computer executable instructions embodied on the non-transitory computer readable storage medium are executed by the processor 301, the computer executable instructions cause the processor 301 to perform the method steps for allowing an applicant 201 to apply for admission to multiple institutions 205 in the online environment.

For purposes of illustration, the detailed description refers to the application management platform 204 being run locally on a computer system 300; however the scope of the computer implemented method and system 200 disclosed herein is not limited to the application management platform 204 being run locally on the computer system 300 via the operating system and the processor 301, but may be extended to run remotely over the network 203 by employing a web browser and a remote server, a mobile phone, or other electronic devices.

The application management platform 204 for allowing an applicant 201 to apply for admission to multiple institutions 205 in an online environment may also be implemented on operating systems for mobile devices, for example, Windows Mobile®, Symbian, Google™ Android, or Apple® iPhone. Mobile implementation uses similar algorithms but may involve different hardware interfaces. For example, the applicant 201 may select the institutions 205 via a touch screen or via voice recognition, and messages may be created using an on-screen keypad or slide-out keyboard, communicating with client software on the mobile device or in a mobile browser. Message transmission then occurs using the mobile device's internet capabilities via a network 203, for example, a WiFi network, a satellite network, a cellular network, etc. The application management platform 204 may also be implemented on two different devices, for example, a desktop and a mobile device, to facilitate communication between them.

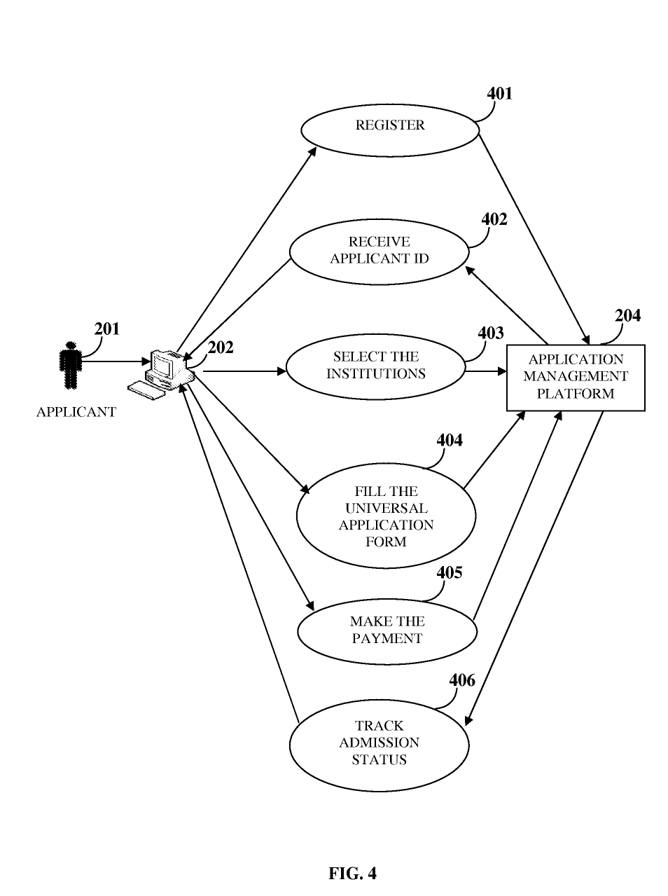

FIG. 4 exemplarily illustrates the interaction between an applicant 201 and the application management platform 204, when the applicant 201 applies for admission to multiple institutions 205 in an online environment. Consider an example where an applicant 201 accesses the application management platform 204, as illustrated in FIG. 2, via the network 203 through a computing device 202 for applying to foreign institutions 205 to study abroad. The applicant 201 registers 401 by creating an account with the application management platform 204 through the online interface 204a. The applicant 201 receives 402 an applicant identifier and password on registration. The applicant 201 logs in to applicant's 201 account using the applicant identifier and the password. The application management platform 204 provides a list of institutions 205 that offer courses or degree programs for the applicant's 201 selection. The applicant 201 selects 403, for example, two institutions 205 listed on the online interface 204a. In response to this selection, the application management platform 204 identifies the applicant information sought by the selected institutions 205 by parsing the application forms associated with the selected institutions 205. For example, among the two institutions 205 selected, the first institution 205 requires the applicant 201 to submit a first application form with input fields, for example, applicant name, date of birth, email address, gender, country of citizenship, immigration status, expected graduation, current degree level, mailing address, etc. The second institution 205 requires the applicant 201 to submit a second application form with input fields, for example, applicant name, date of birth, email address, gender, country of citizenship, immigration status, expected graduation, current degree level, mailing address, etc. Furthermore, the second institution 205 seeks information such as scholarship details and foreign language proficiency details. Therefore, apart from the common input fields, the second application form comprises additional input fields, for example, check boxes for indicating scholarship, a text box for entering a name of a sponsor, etc., radio buttons for indicating degree of proficiency in a foreign language, and file upload controls for uploading any foreign language certifications. The application management platform 204 parses the two application forms of the two institutions 205 and identifies the aforementioned information sought by the two institutions 205.

The application management platform 204 dynamically generates a universal application form with a consolidated set of input fields from the first application form and the second application form. The application management platform 204 consolidates those fields that are common among the two application forms, and appends the additional input fields required by the second application form, for example, the input fields for the scholarship details and the foreign language proficiency details in the universal application form. The applicant 201 fills 404 the consolidated set of input fields with applicant information in prescribed formats in the dynamically generated universal application form. The applicant information filled by the applicant 201 is captured and stored in the data store 204l on the application management platform 204. The captured information is selectively transmitted, for example, via email, to the two institutions 205 in prescribed formats. For example, the applicant information such as scholarship details and foreign language proficiency details may not be transmitted to the first institution 205, if the first institution 205 does not require this information. The applicant 201 makes 405 the payment to the two institutions 205 by transmitting fees associated with the application forms to the two institutions 205 via the application management platform 204. The applicant 201 waits for the admission process after transmitting the fees. The application management platform 204 tracks 406 the status of the admission and sends updates to the applicant 201.

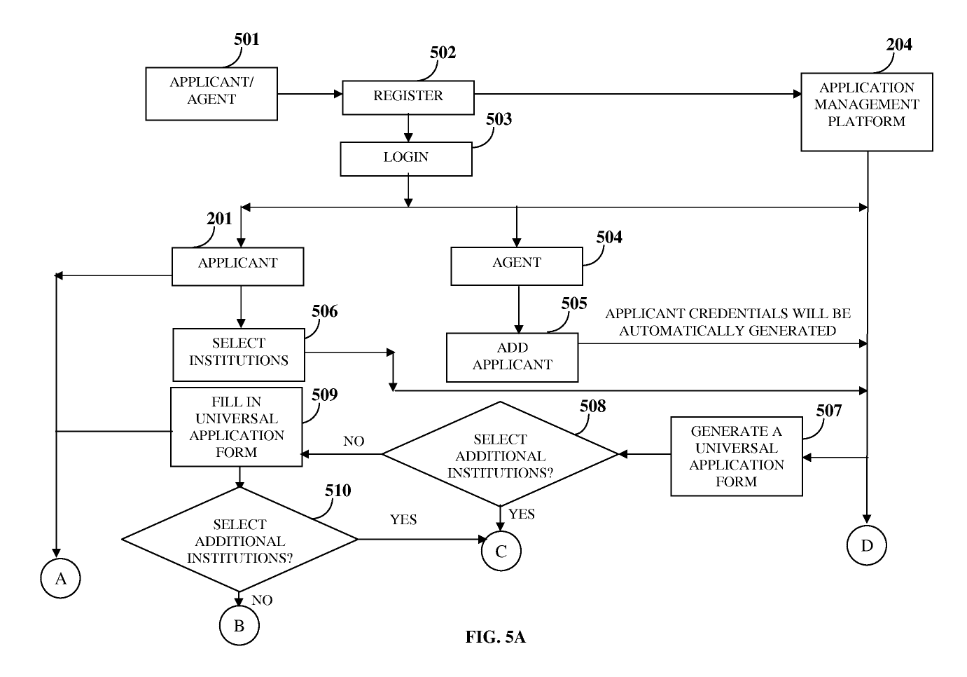

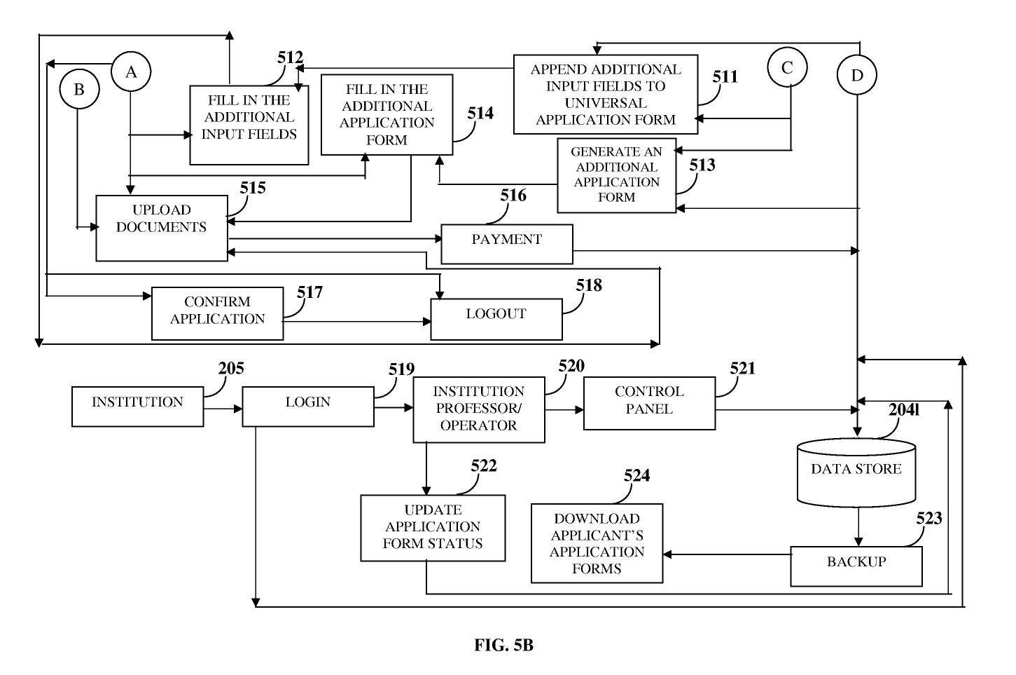

FIGS. 5A-5B exemplarily illustrate a flow chart for allowing an applicant 201 or an agent 504 on behalf of the applicant 201 to apply for admission to multiple institutions 205 in an online environment via the application management platform 204. As used herein, the term “agent” refers to a person or group of persons applying for admission to multiple institutions 205 on behalf of one or more applicants 201. The agent 504 accesses the application management platform 204 through a kiosk located at a pre-designated agent premises. The applicant or the agent 501 on behalf of the applicant 201 registers 502 with the application management platform 204. On registration, the applicant 201 obtains an applicant identifier and password. The agent 504 obtains an agent identifier and password. The registration information is stored in the data store 204l or a database. The applicant or the agent 501 logs 503 into the application management platform 204 via the online interface 204a. On logging in, the agent 504 adds 505 the applicant 201 to a list of applicants herein referred to as “applicant list”. The application management platform 204 automatically generates the applicant's 201 credentials and stores the applicant's 201 credentials and registration information in the data store 204l. On logging in, the application management platform 204 provides a list of institutions 205 to the applicant 201 for selection. The applicant 201 selects 506 one or more institutions 205 from the list of institutions 205. The application management platform 204 identifies applicant information sought by the selected institutions 205 by parsing one or more application forms associated with the selected institutions 205. The application forms associated with the selected institutions 205 are stored in the data store 204l. Each of the application forms associated with the institutions 205 is identified by an application form identifier. The application management platform 204 dynamically generates 507 a universal application form comprising a consolidated set of input fields from the application forms of the selected institutions 205. The application management platform 204 allows the applicant 201 to select additional institutions 205. The application management platform 204 determines if the applicant 201 selects 508 additional institutions 205.

If the applicant 201 selects 508 one or more additional institutions 205, the application management platform 204 retrieves unique applicant information sought by the selected additional institutions 205 from the data store 204l using, for example, a structured query language (SQL) query. The SQL query queries the data store 204l using the application form identifier. The application management platform 204 either reloads the universal application form by appending 511 the additional input fields corresponding to the retrieved unique applicant information to the consolidated set of input fields in the dynamically generated universal application form or generates 513 an additional application form comprising the additional input fields corresponding to the retrieved unique applicant information. In the embodiment where the application management platform 204 reloads the universal application form by appending 511 the additional input fields to the consolidated set of input fields in the dynamically generated universal application form, the applicant 201 fills 512 in the universal application form comprising the consolidated set of input fields and the appended additional input fields. In the embodiment where the application management platform 204 generates 513 an additional application form comprising additional input fields corresponding to the unique applicant information, the applicant 201 fills 514 in the generated additional application form. The applicant 201 then uploads 515 one or more documents associated with the selected institutions 205.

If the applicant 201 does not select 508 additional institutions 205, the applicant 201 directly fills 509 in the dynamically generated universal application form. The application management platform 204 captures and stores the filled applicant information in the data store 204l. When the applicant 201 fills in the dynamically generated universal application form, the application management platform 204 may allow the applicant 201 to select additional institutions 205. The application management platform 204 determines if the applicant 201 selects 510 additional institutions 205. If the applicant 201 selects 510 one or more additional institutions 205, the application management platform 204 retrieves unique applicant information sought by the selected additional institutions 205 from the data store 204l, using an SQL query that queries the data store 204l using the application form identifier. The application management platform 204 either reloads the universal application form by appending 511 the additional input fields corresponding to the unique applicant information to the filled universal application form or generates 513 an additional application form comprising additional input fields corresponding to the unique applicant information. In the embodiment where the application management platform 204 reloads the universal application form, the application management platform 204 retrieves the stored applicant information from the data store 204l, reloads the universal application form with the stored applicant information, and appends 511 the additional input fields corresponding to the unique applicant information to the filled universal application form. The applicant 201 therefore only needs to fill 512 in the appended additional input fields in the reloaded universal application form. In the embodiment where the application management platform 204 generates 513 an additional application form comprising additional input fields corresponding to the unique applicant information, the applicant 201 fills 514 in the generated additional application form. The applicant 201 then uploads 515 one or more documents associated with the selected institutions 205. If the applicant 201 does not wish to select 510 additional institutions 205, after filling in the dynamically generated universal application form, the applicant 201 can proceed to upload 515 one or more documents associated with the earlier selected institutions 205.

The applicant 201 makes 516 a payment by transmitting the fees associated with the selected institutions 205 via the application management platform 204. The application management platform 204 associates the transmitted fees with the applicant identifier of the applicant 201 and stores the information in the data store 204l. The application 201 confirms 517 the application form for submission. The applicant 201 then logs 518 out of the application management platform 204.

An institution operator 520 of one of the selected institutions 205 logs 519 in to the application management platform 204 on behalf of the institution 205 using an institution identifier and an associated password. The application management platform 204 provides a control panel 521 to the institution operator 520 that displays the confirmed application form. The application management platform 204 updates 522 the status of the application form based on inputs from the institution operator 520. The application management platform 204 tracks the status of admission by storing the updated status in the data store 204l. The institution operator 520 can download 524 the filled application forms stored in the data store 204l and initiate the admission process. The data store 204l provides a back up 523 of the captured applicant information and the application forms.

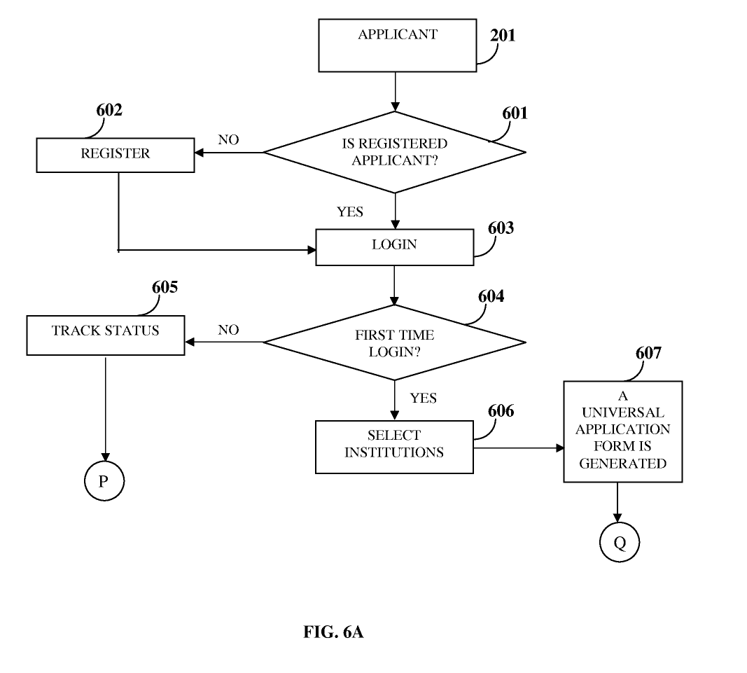

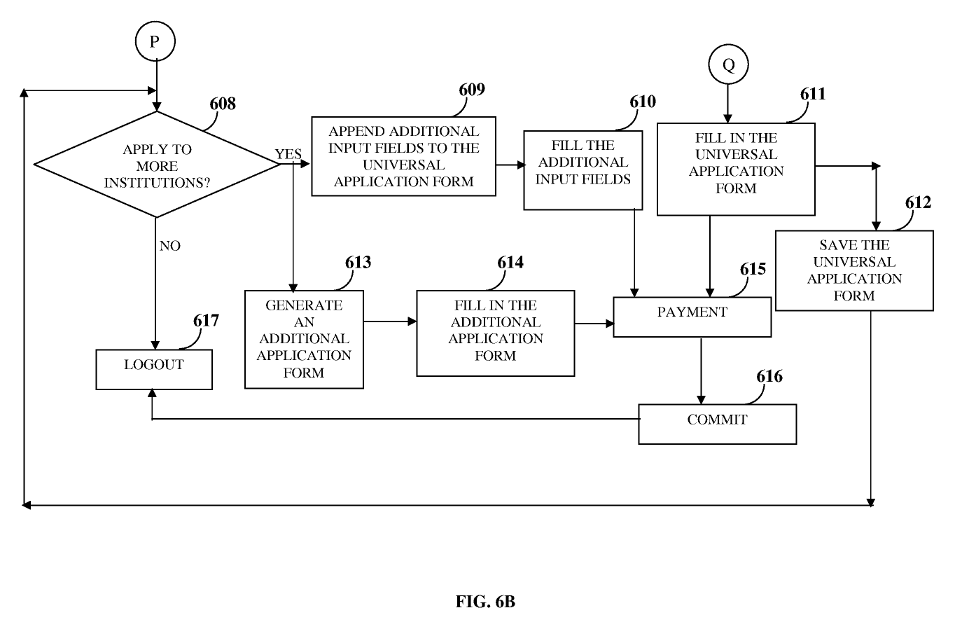

FIGS. 6A-6B exemplarily illustrate a flow chart for allowing an applicant 201 to apply for admission to multiple institutions 205 in an online environment. An applicant 201 accesses the application management platform 204. The application management platform 204 determines 601 if the applicant 201 is a registered applicant. If the applicant 201 is not registered, the applicant 201 registers 602 with the application management platform 204. If the applicant 201 is already registered, the applicant 201 logs 603 in to the application management platform 204. The application management platform 204 determines 604 if the applicant 201 is logging in for the first time. If the applicant 201 is logging in for the first time, the application management platform 204 provides a list of institutions 205 to the applicant 201 for selection. The applicant 201 selects 606 one or more institutions 205 from the list of institutions 205. The application management platform 204 dynamically generates 607 a universal application form as disclosed in the detailed description of FIG. 1. The applicant 201 fills 611 in the dynamically generated universal application form. The application management platform 204 periodically saves 612 the filled universal application form and stores the filled in applicant information. If the applicant 201 is not logging in for the first time, the application management platform 204 tracks 605 the status of admission of the applicant 201. The application management platform 204 determines 608 if the applicant 201 is looking to apply to more institutions 205. If the applicant 201 is not interested in applying to more institutions 205, the applicant 201 logs 617 out of the application management platform 204. If the applicant 201 wishes to apply to more institutions 205, the applicant 201 selects additional institutions 205 and the application management platform 204 retrieves unique applicant information sought by the selected additional institutions 205 from the data store 204l. The application management platform 204 either reloads the universal application form by appending 609 the additional input fields corresponding to the unique applicant information to the consolidated set of input fields in the dynamically generated universal application form or generates 613 an additional application form comprising additional input fields corresponding to the unique applicant information. The applicant 201 fills 610 in the appended additional input fields in the reloaded universal application form having the stored applicant information or the applicant 201 fills 614 in the generated specific application form.

The applicant 201 makes 615 the payment by transmitting the fees associated with the institution 205 via the application management platform 204. The applicant 201 commits 616 by storing the information pertaining to the admission in the data store 204l of the application management platform 204. The applicant 201 logs 617 out of the application management platform 204.

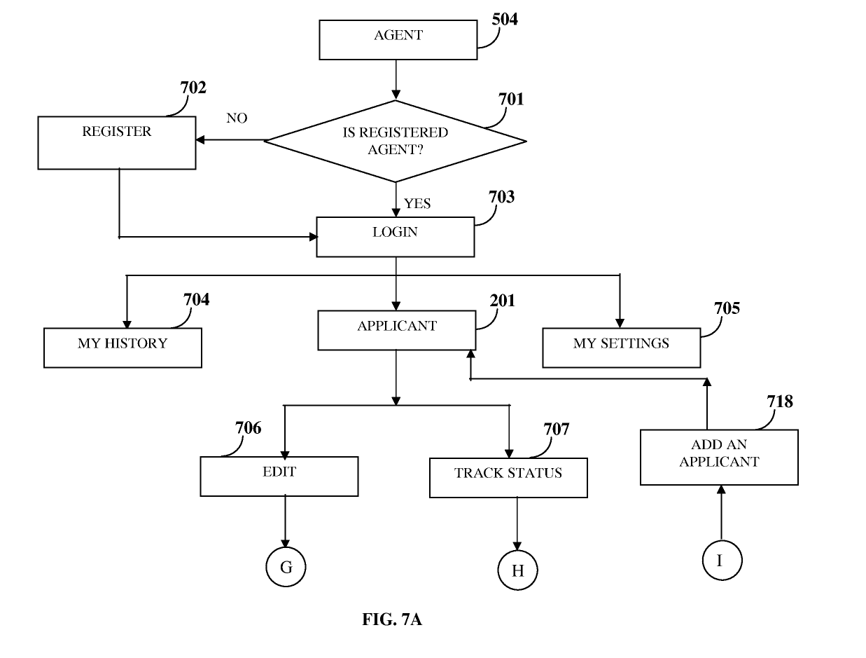

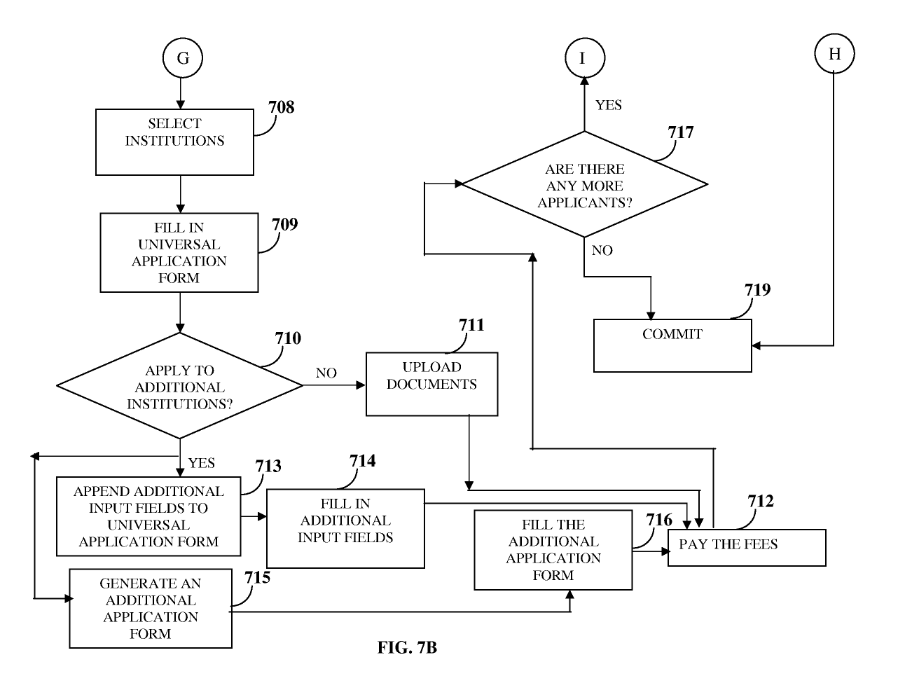

FIGS. 7A-7B exemplarily illustrate a flow chart for allowing an agent 504 on behalf of the applicant 201 to apply for admission to multiple institutions 205 in an online environment. An agent 504 accesses the application management platform 204. The application management platform 204 determines 701 if the agent 504 is a registered agent. If the agent 504 is not registered, the agent 504 registers 702 with the application management platform 204. If the agent 504 is already registered, the agent 504 logs 703 in to the application management platform 204. The online interface 204a displays three options to the agent 504, “my history” 704, “applicant” 201, and “my settings” 705. The option “my history” 704 displays information of an applicant 201 previously registered by the agent 504. The option “my settings” 705 specifies the changes made by the agent 504 to the agent information, for example, password, email address, profile information, etc.

If the agent 504 selects the applicant 201 option, the agent 504 is presented with options namely “edit” 706 and “track status” 707. On selecting the option “edit” 706, the agent 504 selects 708 one or more institutions 205 for the applicant's 201 admission. The agent 504 fills 709 in the dynamically generated universal application form on behalf of the applicant 201. The application management platform 204 stores the filled in applicant information in the data store 204l. The application management platform 204 determines 710 if the agent 504 wishes to apply to additional institutions 205. If the agent 504 does not wish to apply to additional institutions 205, the agent 504 can upload 711 one or more documents required by the selected institutions 205. The agent 504 pays 712 the fees associated with the application forms of the selected institutions 205. If the agent 504 wishes to apply 710 to additional institutions 205 on behalf of the applicant 201 and selects additional institutions 205, the application management platform 204 retrieves unique applicant information sought by the selected additional institutions 205 from the data store 204l. The application management platform 204 either reloads the universal application form by appending 713 the additional input fields corresponding to the unique applicant information to the consolidated set of input fields in the dynamically generated universal application form or generates 715 an additional application form comprising additional input fields corresponding to the unique applicant information. In the embodiment where the application management platform 204 reloads the universal application form by appending 713 the additional input fields corresponding to the unique applicant information to the dynamically generated universal application form, the agent 504 fills 714 in the appended additional input fields in the reloaded universal application form having the stored applicant information. In the embodiment where the application management platform 204 generates 715 an additional application form comprising additional input fields corresponding to the unique applicant information, the agent 504 fills 716 in the generated additional application form.

The agent 504 pays 712 the fees associated with the application forms of the selected institutions 205. The agent 504 then checks 717 for other applicants 201 applying to institutions 205. If there are more applicants, the agent 504 adds 718 the other applicants 201 to the applicant list and performs the above mentioned steps for each of the applicants 201. The agent 504 then commits 719 by storing the information pertaining to all the applicants 201 in the data store 204l of the application management platform 204. On selecting the option “track status” 707, the agent 504 updates the status of the admission of the applicants 201 in the data store 204l via the application management platform 204 and then commits 719 by storing the information pertaining to all the applicants 201 in the data store 204l.

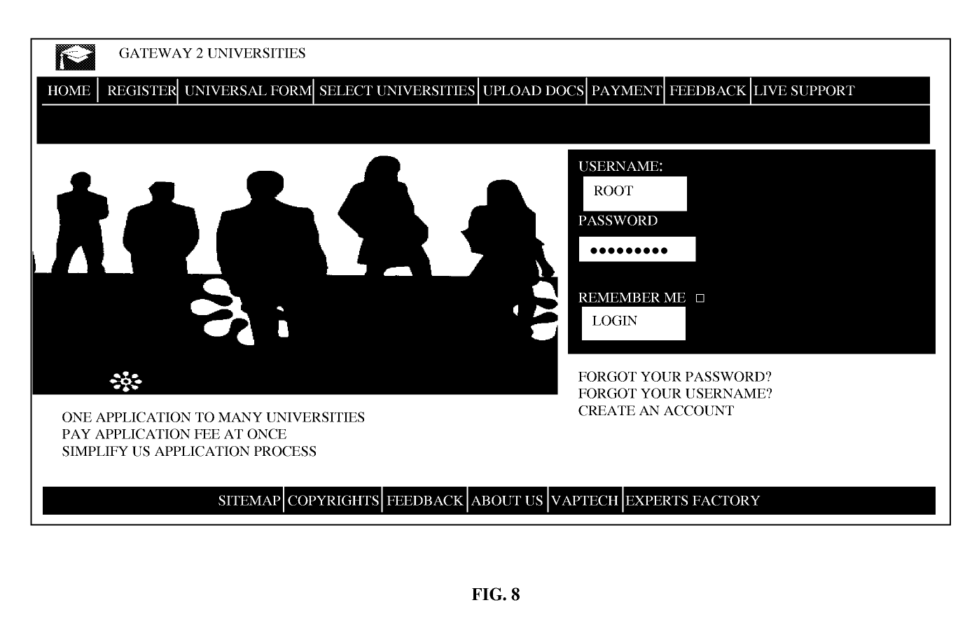

Consider an example of an applicant 201 applying to multiple institutions 205 in an online environment. The applicant 201 registers with the application management platform 204 to create an account and obtains an applicant identifier and password for accessing the account. During registration, the applicant 201 provides applicant information comprising, for example, applicant's 201 name, applicant's 201 age, a desired username for the applicant 201, mailing address, phone number, and email address. On registration, the applicant 201 obtains an applicant identifier and password for accessing the account. The applicant 201 logs into the application management platform 204 using the applicant identifier and the password. FIG. 8 exemplarily illustrates a screenshot of the online interface 204a provided by the application management platform 204 for enabling an applicant 201 to log in to the application management platform 204. The online interface 204a presents the applicant 201 with input boxes for entering the username and the password. On clicking the login button, the application management platform 204 authenticates the applicant 201. The online interface 204a presents the applicant 201 with options to retrieve the password of the applicant 201 stored on the data store 204l and the username of the applicant 201 stored on the data store 204l, and to create an account.

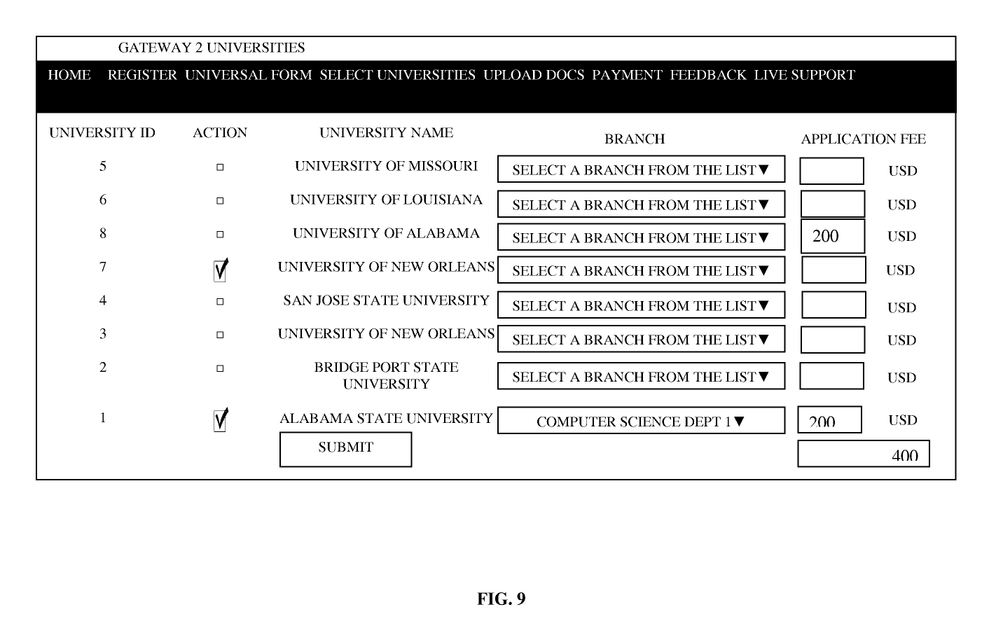

When the applicant 201 logs in, the online interface 204a presents the applicant 201 with options to apply to multiple institutions 205 such as universities with a single universal application form, to pay the fees associated with the admission, and to simplify the admission process. The application management platform 204 displays a list of institutions 205 on the online interface 204a. FIG. 9 exemplarily illustrates a screenshot of the online interface 204a for enabling the applicant 201 to select one or more institutions 205 from a list of institutions 205 for admission. The online interface 204a displays an institution identifier associated with each institution 205, an institution name, a list of branches, streams, or academic programs to choose from, a text box for entering the fees associated with admission to an institution 205, and a currency type associated with the fees. Furthermore, a checkbox is provided for the applicant 201 to perform an input action for selecting one or more institutions 205 from the list of institutions 205 displayed on the online interface 204a. The applicant 201 selects, for example, Alabama State University and University of New Orleans from the list via the online interface 204a, enters the fees for the application forms associated with Alabama State University and University of New Orleans. The application management platform 204 identifies applicant information required by Alabama State University and University of New Orleans by parsing the application forms associated with Alabama State University and University of New Orleans.

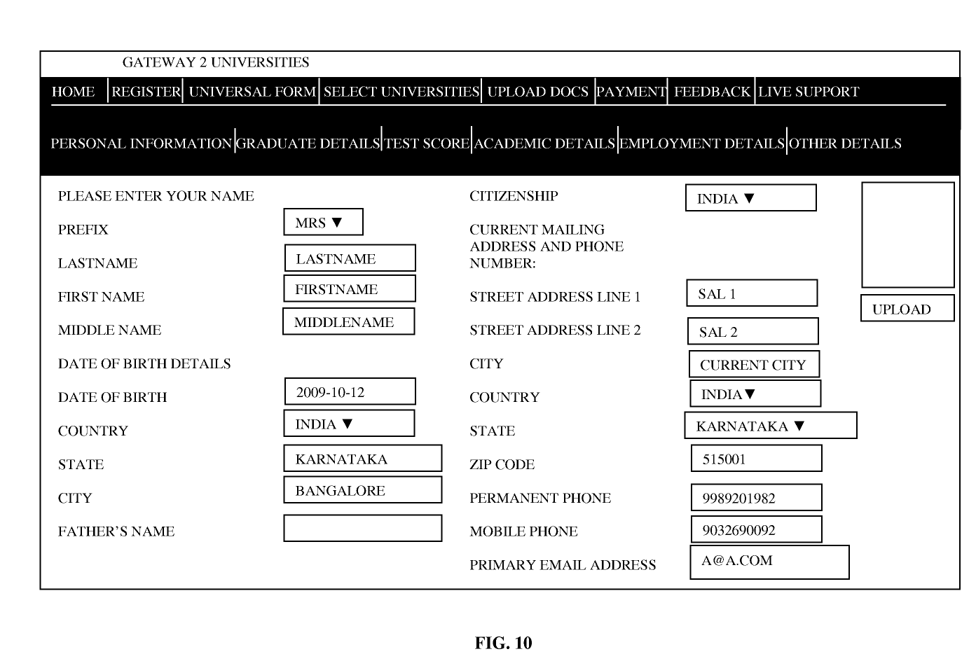

The application management platform 204 dynamically generates a universal application form comprising a consolidated set of input fields corresponding to the identified applicant information. FIG. 10 exemplarily illustrates a screenshot of the online interface 204a displaying a dynamically generated universal application form. The universal application form comprises the consolidated set of input fields, for example, input boxes for the applicant's 201 name, the prefix to the applicant's 201 name such as Ms. and Mr., the applicant's 201 last name, the applicant's 201 first name, the applicant's 201 middle name, the applicant's 201 date of birth, the applicant's 201 country of birth, the applicant's 201 state of birth, the applicant's 201 city of birth, the applicant's 201 father's name, the applicant's 201 country of citizenship, the applicant's 201 current mailing address, the applicant's 201 street address, the applicant's 201 country of residence, the applicant's 201 state of residence, the applicant's 201 city of residence, the zip code associated with the mailing address, the applicant's 201 permanent phone number, the applicant's 201 mobile phone number, the applicant's 201 primary email address, and a link to upload one or more documents associated with admission.

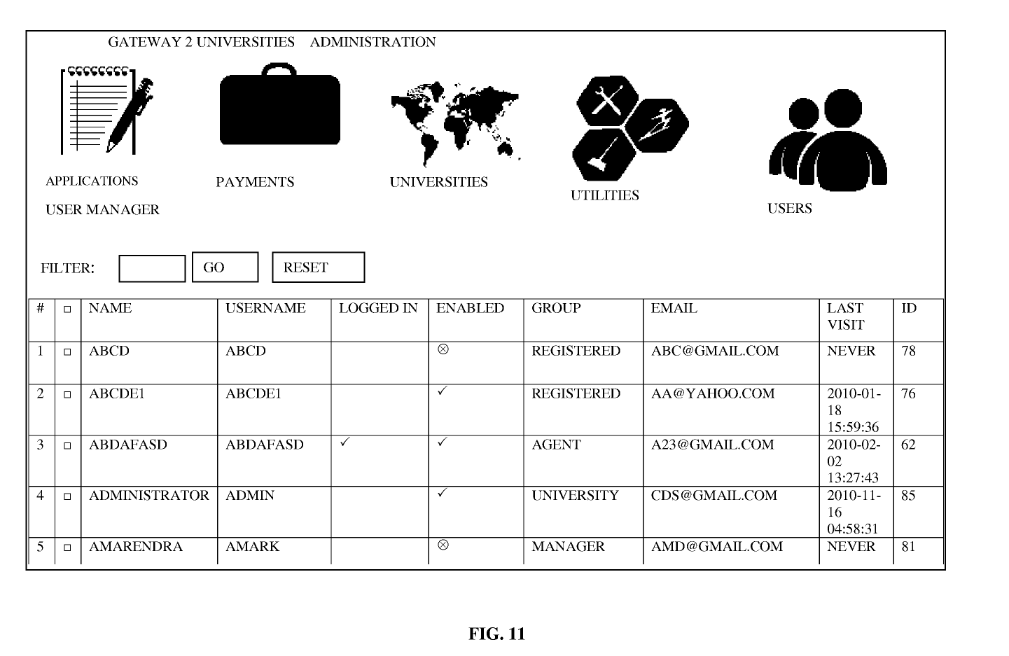

The application management platform 204 captures the applicant information when the applicant 201 fills out the dynamically generated universal application form via the online interface 204a. The application management platform 204 selectively transmits the captured applicant information from the filled universal application form to the Alabama State University and University of New Orleans. An administrator of the application management platform 204 tracks the status of admission of multiple applicants 201 on the application management platform 204 via the online interface 204a. FIG. 11 exemplarily illustrates a screenshot of the online interface 204a for tracking the status of admission of multiple applicants 201 to selected institutions 205 on the application management platform 204. The online interface 204a of the application management platform 204 provides the administrator with options for viewing the universal application form, payments made by the applicants 201, the list of universities or institutions 205, utilities, etc. The application management platform 204 also provides a control panel to view information, for example, the applicant's 201 or an agent's 504 email address, the time of the last visit of the applicant 201 or the agent 504, the identifier uniquely identifying the applicant 201 or the agent 504, to determine whether the applicant 201 or the agent 504 is logged in to the application management platform 204 at the present time, to determine whether the applicant 201 or the agent 504 is registered, etc. The application management platform 204 lists the applicants 201 displayed based on certain filter criteria for selecting a range for the displayed applicant information.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the data store 204l, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method for allowing an applicant to apply for admission to a plurality of institutions in an online environment, comprising:
providing an application management platform, wherein said application management platform provides an online interface to said applicant for applying to said institutions in said online environment;
providing a list of said institutions to said applicant by said application management platform via said online interface, wherein said applicant selects one or more of said institutions from said list;
identifying applicant information sought by said selected one or more institutions by parsing application forms associated with said selected one or more institutions;
dynamically generating a universal application form comprising a consolidated set of input fields corresponding to said identified applicant information;
capturing applicant information filled into said consolidated set of input fields of said dynamically generated universal application form by said applicant via said online interface; and
selectively transmitting said captured applicant information from said filled universal application form to said selected one or more institutions by said application management platform;
whereby consolidating said set of input fields in said dynamically generated universal application form for capturing said applicant information sought by said selected one or more institutions in said online environment provides an integrated means for applying to said selected one or more institutions.

2. The computer implemented method of claim 1, wherein said captured applicant information is periodically stored in a data store residing on said application management platform.

3. The computer implemented method of claim 1, further comprising identifying unique applicant information sought by one or more of said institutions subsequently selected by said applicant on said online interface by said application management platform.

4. The computer implemented method of claim 3, further comprising appending additional input fields to said consolidated set of input fields in said dynamically generated universal application form, wherein said additional input fields correspond to said identified unique applicant information.

5. The computer implemented method of claim 3, further comprising generating an additional application form specific to each of said subsequently selected one or more institutions, wherein said additional application form comprises additional input fields corresponding to said identified unique applicant information.

6. The computer implemented method of claim 1, further comprising registering said applicant and said institutions with said application management platform and automatically generating credentials for said applicant and said institutions by the application management platform for accessing said captured applicant information.

7. The computer implemented method of claim 1, further comprising generating reports using said captured applicant information based on requirements of said selected one or more institutions.

8. The computer implemented method of claim 1, further comprising capturing electronic payment details from said applicant via said online interface for transmitting fees associated with said admission to said selected one or more institutions over a plurality of secure connections.

9. The computer implemented method of claim 1, wherein one or more of said consolidated set of input fields in said dynamically generated universal application form prompts said applicant to fill said applicant information in a format prescribed by said selected one or more institutions.

10. The computer implemented method of claim 1, wherein one or more of said consolidated set of input fields in said dynamically generated universal application form allows said applicant to one of attach and upload one or more documents associated with said admission.

11. The computer implemented method of claim 1, further comprising automatically filling in said application forms associated with said selected one or more institutions using said captured applicant information from said filled universal application form, wherein said filled application forms are transmitted to said selected one or more institutions.

12. The computer implemented method of claim 1, further comprising tracking status of said admission of said applicant to each of said selected one or more institutions by said application management platform.

13. The computer implemented method of claim 1, further comprising providing a messaging interface in association with said online interface for enabling interactive communication between said applicant and said selected one or more institutions via said application management platform.

14. A computer implemented system for allowing an applicant to apply for admission to a plurality of institutions in an online environment, comprising:
an application management platform comprising:
an online interface that enables said applicant to apply to said institutions in said online environment;
a listing module that provides a list of said institutions to said applicant via said online interface, wherein said applicant selects one or more of said institutions from said list;
a parsing engine that identifies applicant information sought by said selected one or more institutions by parsing application forms associated with said selected one or more institutions;
a universal application form generation module that dynamically generates a universal application form comprising a consolidated set of input fields corresponding to said identified applicant information;
an information capture module that captures applicant information filled into said consolidated set of input fields of said dynamically generated universal application form by said applicant via said online interface; and
an information transmission module that selectively transmits said captured applicant information from said filled universal application form to said selected one or more institutions.

15. The computer implemented system of claim 14, wherein said application management platform further comprises a data store that periodically stores said application forms, said dynamically generated universal application form, said captured applicant information, said filled universal application form, and automatically filled application forms for said selective transmission to said selected one or more institutions.

16. The computer implemented system of claim 14, wherein said parsing engine identifies unique applicant information sought by one or more of said institutions subsequently selected by said applicant on said online interface.

17. The computer implemented system of claim 16, wherein said universal application form generation module appends additional input fields to said consolidated set of input fields in said dynamically generated universal application form, wherein said additional input fields correspond to said identified unique applicant information.

18. The computer implemented system of claim 16, wherein said universal application form generation module generates an additional application form specific to each of said subsequently selected one or more institutions, wherein said additional application form comprises additional input fields corresponding to said identified unique applicant information.

19. The computer implemented system of claim 14, wherein said application management platform further comprises a registration module that registers said applicant and said institutions with said application management platform, wherein said registration module automatically generates credentials for said applicant and said institutions for accessing said captured applicant information.

20. The computer implemented system of claim 14, wherein said application management platform further comprises an report generation module that generates reports using said captured applicant information based on requirements of said selected one or more institutions.

21. The computer implemented system of claim 14, wherein said application management platform further comprises an admission management module that automatically fills in said application forms associated with said selected one or more institutions using said captured applicant information from said filled universal application form, wherein said admission management module tracks status of said admission of said applicant to each of said selected one or more institutions.

22. The computer implemented system of claim 14, wherein said online interface comprises a fee payment interface that captures electronic payment details from said applicant for transmitting fees associated with said admission to said selected one or more institutions over a plurality of secure connections.

23. The computer implemented system of claim 14, wherein said online interface comprises a messaging interface that enables interactive communication between said applicant and said selected one or more institutions via said application management platform.

24. A computer program product comprising computer executable instructions embodied in a non-transitory computer readable storage medium, wherein said computer program product comprises:
a first computer program code for providing an application management platform that provides an online interface to said applicant for applying to a plurality of institutions in an online environment;
a second computer program code for providing a list of said institutions to said applicant by said application management platform via said online interface, wherein said applicant selects one or more of said institutions from said list;
a third computer program code for identifying applicant information sought by said selected one or more institutions by parsing application forms associated with said selected one or more institutions;
a fourth computer program code for dynamically generating a universal application form comprising a consolidated set of input fields corresponding to said identified applicant information;
a fifth computer program code for capturing said applicant information filled into said consolidated set of input fields of said dynamically generated universal application form by said applicant via said online interface; and
a sixth computer program code for selectively transmitting said captured applicant information from said filled universal application form to said selected one or more institutions by said application management platform.

25. The computer program product of claim 24, further comprising:
a seventh computer program code for identifying unique applicant information sought by one or more of said institutions subsequently selected by said applicant on said online interface by said application management platform; and
an eighth computer program code for appending additional input fields to said consolidated set of input fields in said dynamically generated universal application form, wherein said additional input fields correspond to said identified unique applicant information.
